(19) United States
(12) Patent Application Publication
(10) Pub. No.: US 2012/0143420 A1
(43) Pub. Date: Jun. 7, 2012

(54) VEHICLE OPERATION MODE SYSTEMS AND METHODS

(75) Inventors: Henrik FISKER, Los Angeles, CA (US); Thomas FRITZ, Ann Arbor, MI (US); Paul E. BOSKOVITCH, Costa Mesa, CA (US); Kevin WALSH, Orange, CA (US)

(73) Assignee: Fisker Automotive, Inc.

(21) Appl. No.: 13/197,608

(22) Filed: Aug. 3, 2011

Related U.S. Application Data
(60) Provisional application No. 61/370,561, filed on Aug. 4, 2010.

(51) Int. Cl. B60W 20/00; G06F 19/00

(52) U.S. Cl. 701/22; 903/930; 903/947; 180/65.245

(57) ABSTRACT

A system for controlling a mode of operation of a vehicle having a rechargeable energy storage system (RESS), an engine, and a drive motor coupled to the RESS and the engine, the drive motor selectively powered by at least one of the RESS and the engine includes a controller operable to adjust the vehicle to operate in a plurality of operating modes including a first mode in which the drive motor is powered by the RESS, a second mode in which the drive motor is powered more by the engine than the RESS, and a third mode in which the drive motor is powered by both the RESS and the engine. The third mode includes a plurality of braking modes adjusting the level of automatic brake power and manually requested brake power for providing resistance to the vehicle as the vehicle travels.

### CROSS-REFERENCE TO RELATED PATENT APPLICATIONS

The present invention relates to U.S. Provisional Patent Application 61/370,561, filed on Aug. 4, 2010, and entitled “STEALTH, SPORT, AND HILL VEHICLE OPERATION MODES,” which is incorporated herein in its entirety and forms a basis for a claim of priority.

### BACKGROUND

1. Field

The present disclosure relates generally to hybrid or electric vehicles, and particularly to a plurality of operating modes associated with hybrid or electric vehicles.

2. Related Art

Vehicles, such as motor vehicles, utilize an energy source in order to provide power to operate the vehicle. While petroleum-based products, such as gasoline, dominate as an energy source in traditional combustion engines, alternative energy sources are available, such as methanol, ethanol, natural gas, hydrogen, electricity, solar, and/or the like. A hybrid powered vehicle, referred to as a “hybrid vehicle,” utilizes a combination of energy sources in order to power the vehicle. For example, a battery maybe utilized in combination with the traditional combustion engine to provide power to operate the vehicle. Such vehicles are desirable because they take advantage of the benefits of multiple fuel sources in order to enhance performance and range characteristics of the hybrid vehicle relative to a comparable gasoline-powered vehicle.

An example of a hybrid vehicle is a vehicle that utilizes a combination of stored electric energy and an internal combustion engine as power sources to propel the vehicle. An electric vehicle is environmentally advantageous due to its low emissions characteristics and the general availability of electricity as a power source. The battery may be quite large, depending on the energy requirements of the vehicle, and will generate heat that is dissipated using various techniques. Batteries can be quiet emitting low sound. Adjustment between a supplemental energy source, like an engine, can be improved to provide desired vehicle performance characteristics.

### SUMMARY OF THE DISCLOSURE

Various embodiments allow an electric or hybrid electric-powered vehicle to provide adjustment between using multiple energy sources and increased performance related to environmental factors, power factors, and longevity factors. In various embodiments, a power and efficiency management system for a vehicle is provided. In various embodiments, various operating modes can be employed by the driver to create a desired look, feel, and sound. In various embodiments, the life of consumable parts such as brake pads can be increased. Various embodiments provide for an improved interaction between the engine and the battery to provide added efficiency and performance.

### BRIEF DESCRIPTION OF THE DRAWINGS

FIG. 1 is a chart representing various modes according to an embodiment of the disclosure.

FIG. 2 illustrates a perspective view of an example steering wheel having a pair of hand pedals for adjusting between multiple operational modes according to an embodiment of the disclosure.

FIG. 3 illustrates a front view of an example steering wheel according to an embodiment of the disclosure.

FIG. 4 illustrates a left front view of an example pedal mounted on a steering wheel according to an embodiment of the disclosure.

FIG. 5 illustrates a right front view of an example pedal mounted on a steering wheel according to an embodiment of the disclosure.

FIG. 6 illustrates an example steering wheel according to an embodiment of the disclosure.

FIG. 7 illustrates an example pedal mounted on a steering wheel according to an embodiment of the disclosure.

FIG. 8 illustrates a side view of a pedal mounted on a steering wheel according to an embodiment of the disclosure.

FIG. 9 illustrates a front view of pedals according to an embodiment of the disclosure.

FIG. 10 illustrates a back side rear view of pedals according to an embodiment of the disclosure.

### DETAILED DESCRIPTION

A vehicle, such as a hybrid vehicle, includes a rechargeable energy storage system (RESS) coupled with an engine. The engine may generally refer to any apparatus operable to augment power or range beyond the RESS. For example, the engine can be an internal combustion engine that consumes gasoline. The RESS can be, for example (but not limited to) a high-voltage battery, such as a high-voltage lithium ion battery pack. Operation of the vehicle can be driven by each power source and/or both. The vehicle can include one or more drive motors. The drive motors can be electrically driven and coupled to the engine and the RESS. The motors engage a drive shaft that turns one or more wheels of the vehicle.

When the vehicle accelerates or increases energy consumption, speed of the drive motor increases to deliver more power or energy to the wheels. The turning of the motors can be reversed to provide regenerative braking, which provides the impression of down-shifting the vehicle. This also generates energy that can be stored in the RESS. Accordingly, in some embodiments, the vehicle can actuate regenerative braking to slow the vehicle rather than causing brake pads to slow the wheels of the vehicle when a brake pedal of the vehicle is depressed. To slow the vehicle beyond the speed caused by the regenerative braking, the brake pads can engage the wheels under predetermined circumstances that are input into a controller of the vehicle. For instance, the brake pads can take over once requested braking surpasses a prefixed set point or threshold.

Various embodiments provide for one or more driver-selectable powertrain operating modes for a vehicle such as a hybrid vehicle. In some embodiments, a first mode or “stealth” mode is a default operating mode for the vehicle. In stealth mode, fuel economy can be favored over performance. To favor fuel economy, the vehicle is powered by the RESS (e.g., high-voltage battery) with little or no supplemental power from the engine. The RESS is used to operate the vehicle until the RESS reaches a state of charge threshold. The state of charge threshold may be predetermined and programmed into a controller of the vehicle. The state of charge threshold may be targeted to maintain battery longevity and performance targets. In stealth mode, the vehicle controller is programmed to prevent engine operation until the RESS reaches its target state of charge threshold.

Stealth mode allows for quiet vehicle operation for both a driver of the vehicle and to outside observers. Accordingly, this can provide a desired “stealth” look, feel, and sound. The vehicle can emit a particular sound when operating in stealth mode that enhances the “stealth” impression. An external sound system composed of at least a speaker and a sound controller can be included in and/or on the vehicle. The sound controller generates sounds based on vehicle and driver behavior and sends the sounds to the speakers. For example, acceleration can emit a first sound, braking can emit a second sound, and other behaviors like starting and turning off the vehicle can emit additional sounds.

Stealth mode can affect the powertrain thermal strategy. Suitable heating and cooling management of batteries, motors, engines, power electronics, and/or the like can affect vehicle operation performance. For example, lower power limits or higher coolant temperature limits can be specified in stealth mode to reduce fan and pump loads. Accordingly, the thermal system would not have to work as hard if the cooling needs are limited. This decrease in energy consumption may correspond to better fuel economy. In a further example, customer comfort requirements can be relaxed for better fuel economy (e.g., by limiting power allowed for seat heating).

Selection of stealth mode can affect other systems outside of the powertrain system of the vehicle to correlate the driving experience to environmental-friendliness factors. In some embodiments, an acoustic signature of the vehicle can change via active interior and/or exterior sound enhancement. In some embodiments, the vehicle includes a display screen displaying the vehicle along with other features. The features can be customizable. The visual appearance of the vehicle can change on the display screen in stealth mode. Interior and/or exterior lighting can further be changed when operating in stealth mode. Tactile feedback to the driver may change as well.

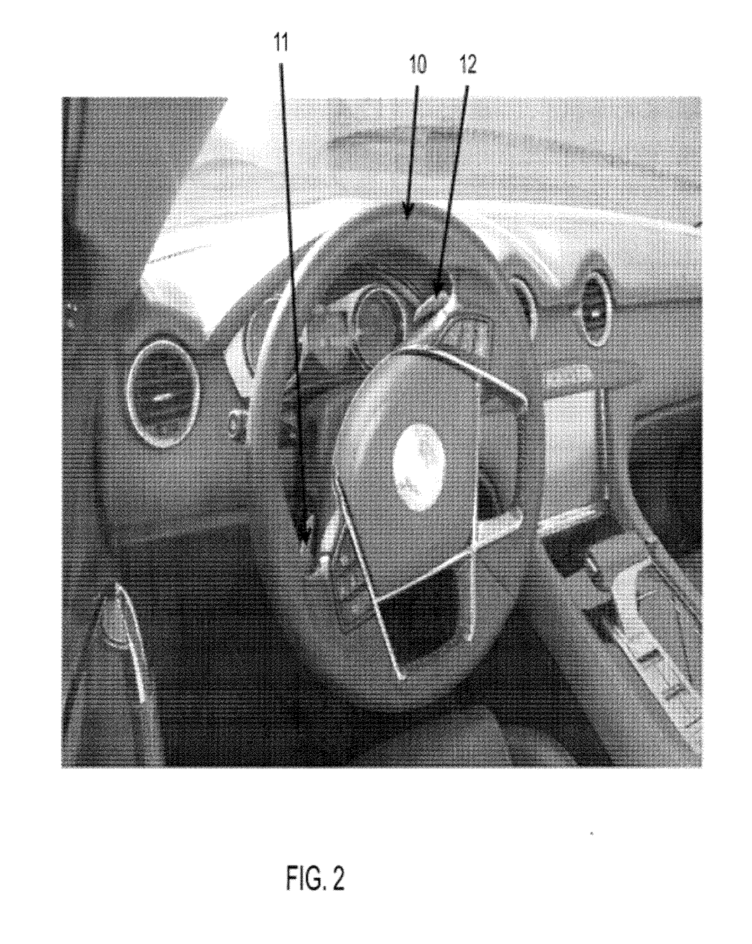

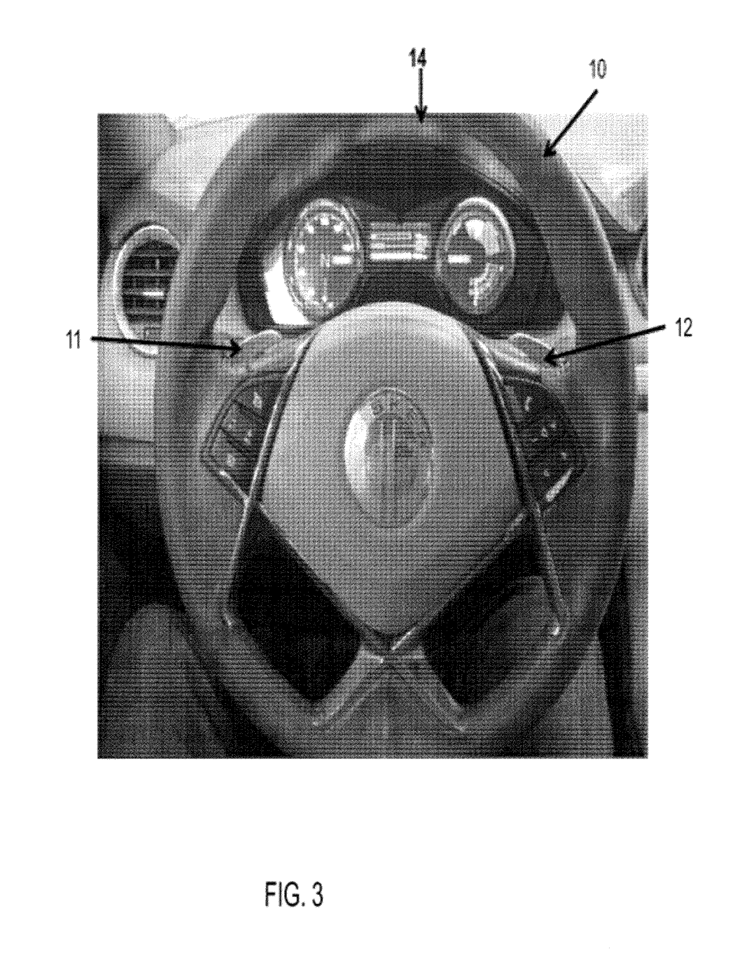

A second mode or “sport” mode can be a selectable mode that emphasizes performance aspects of the vehicle by allowing for engine operation to aid more than the RESS as compared to stealth mode. In an example, the driver can switch to sport mode and back to stealth via a bidirectional push/pull sport hand paddle 11 on a steering wheel 10 as seen in FIGS. 2, 3,4, 6, and 9. In the sport mode, the vehicle uses more than one power source to achieve performance targets. The engine may still turn off when the driver does not demand a lot of power, but without significantly sacrificing response time. Sport mode can affect various systems of the vehicle as well, but with the target of creating a performance-oriented driving experience.

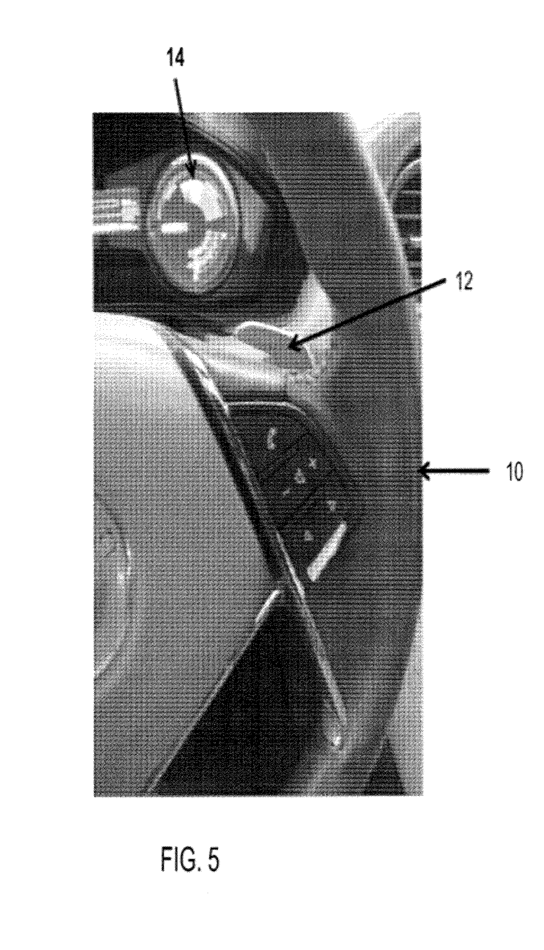

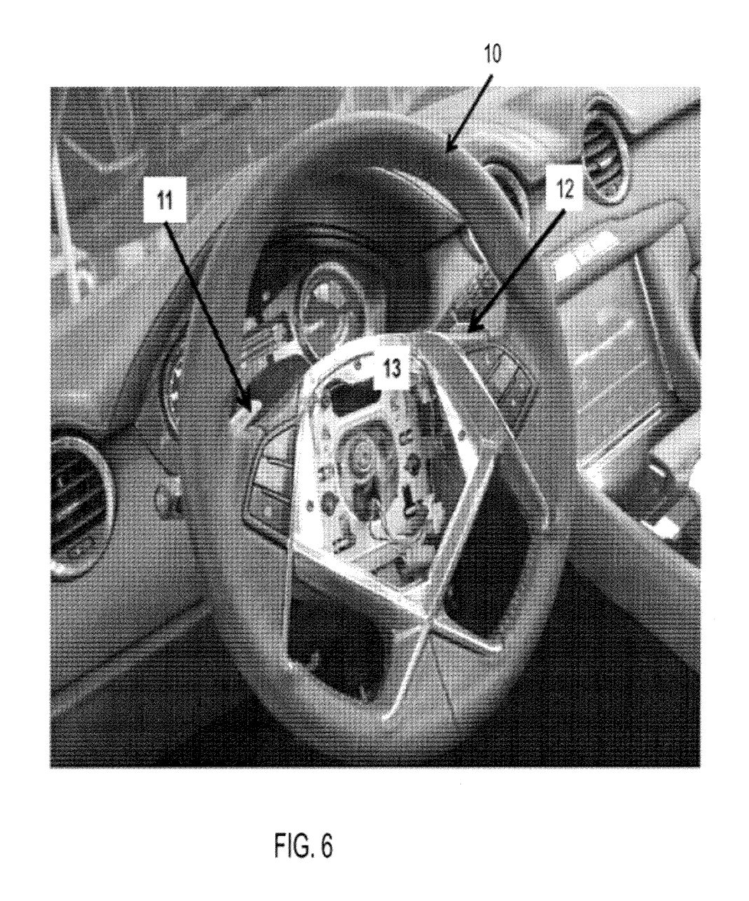

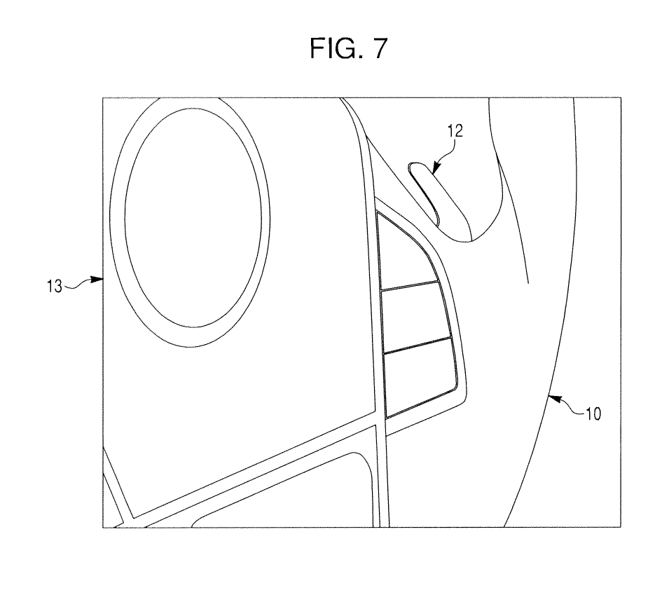

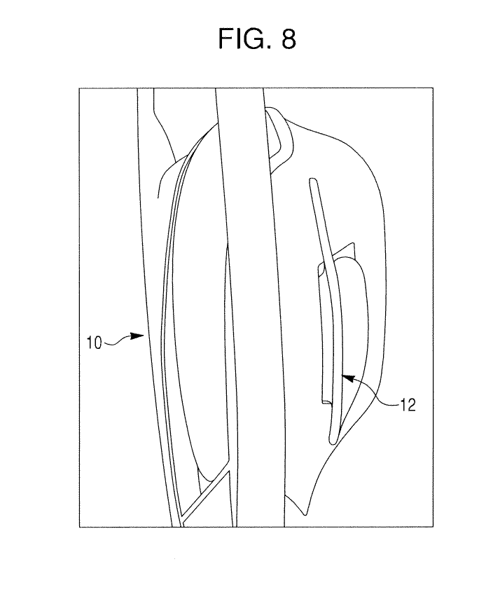

A third mode or “hill” mode can be a selectable mode that improves drivability of the vehicle. Hill mode is a form of electronic downshifting using the RESS and the engine. In some embodiments, in hill mode, a suitable amount of resistance can be provided when driving downhill. This resistance may correlate to speed and can simulate the feel of downshifting in a conventional vehicle. In an example, the driver can change hill mode via a bidirectional (push/pull) hill paddle 12 on the steering wheel 10 as seen in FIGS. 2, 3, and 5-10.

In various embodiments, hill mode can include a plurality of selectable levels of resistance. For example, three selectable levels of resistance may be provided—H1, H2, and H3. This can be analogous, for example, to three low gears in a transmission. A higher number indicates higher resistance (i.e., higher automatic regenerative braking). Each successive hill paddle 12 pull or push inputs change resistance, for example: OFF→H1→H2→H3→OFF. The driver can also decrement the hill resistance by pushing the hill paddle 12. Any number of modes or engagement/disengagement orders can be employed.

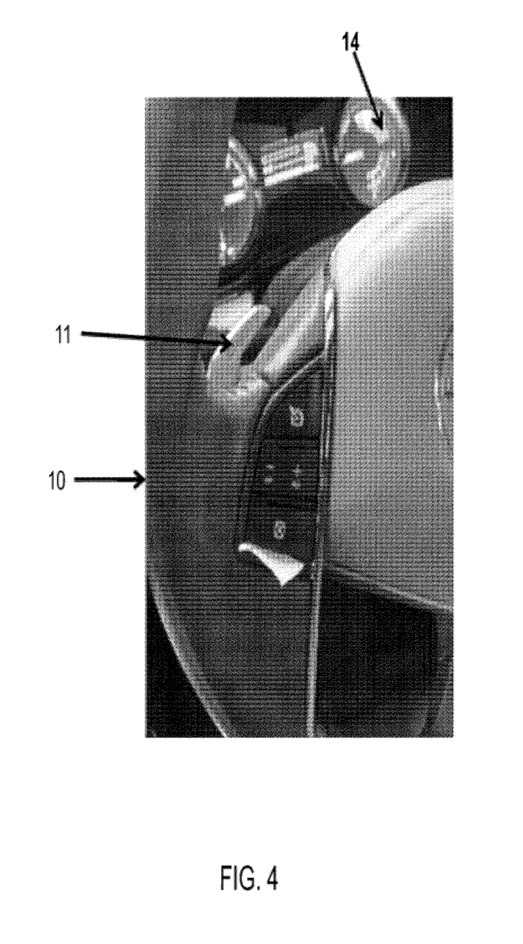

In an example as shown in FIGS. 2-10, the sport paddle 11 and hill paddle 12 are positioned on opposite sides of the steering wheel 10 near typical or comfortable hand positions on the steering wheel 10. In this example, the sport paddle 11 is on a left side and the hill paddle 12 is on the right side. To communicate functionality to the driver, the words “sport” and “hill” can be formed on each of the respective paddles.

In various embodiments, the vehicle enters hill mode automatically by sensing the grade of the road, or vary resistance automatically within a hill mode. For example, a threshold grade can be input into a vehicle controller that is coupled to the transmission. A level sensor or GPS system may send a signal to the controller indicating that the vehicle was driving along a certain grade that reached a preset threshold for driving in hill mode. In some embodiments, the controller may cause the vehicle to switch to hill mode upon receiving the signal. In particular embodiments, the controller may cause the vehicle to switch to a particular hill mode level that corresponds to the detected grade upon receiving the signal.

In various embodiments, hill mode provides relatively consistent resistance regardless of vehicle conditions. Hill mode can generate resistance using several methods, including, but not limited to regenerative braking, using more electricity, engine braking, friction braking, and/or the like.

In some embodiments, regenerative braking may be used to generate resistance. In particular embodiments, the traction motors are engaged as generators to provide energy to the RESS. During downhill or down-grade driving, the engine recharges the RESS.

In some embodiments, resistance may be generated by using more electricity (i.e., more electric energy than normal). The vehicle may do this when the RESS has a full charge. Electrical systems of the vehicle would receive energy either directly from the regenerative braking system or from the RESS. The vehicle could use this energy to cool the battery and motors more aggressively or effectively waste energy by running systems and components inefficiently that would not have operated otherwise. Wasting electrical energy is an alternative to wearing down the brake pads. In some embodiments, electric motors can be used similarly to eddy current brakes by variably short circuiting the electric motor phases through the inverters, thus dissipating energy within the electric motors as heat.

In some embodiments, resistance may be generated by engine braking (e.g., dissipating energy by spinning the engine). If the engine can mechanically drive the wheels, this engine braking is similar to that of a traditional automatic transmission vehicle. If, however, the engine has no mechanical connection to the wheels, as in an example plug-in hybrid vehicle, the vehicle can still dissipate energy by spinning the engine with a generator. The generator would receive energy either directly from the regenerative braking system or from the RESS. The vehicle may do this, for example, when the RESS has a full charge. Engine braking could maintain full hill mode resistance.

In some embodiments, resistance may be generated by friction braking (e.g., engaging brake pads and rotors). The vehicle may do this when the RESS has a full charge and the methods listed above cannot reasonably dissipate enough power or would otherwise be undesired (e.g., to do so would cause severe wear). On a vehicle with regenerative braking, the brake pads get much less use than a conventional vehicle. As such, the use of the brake pads in this scenario would not significantly reduce (if at all) life of the brake pads below that of a conventional vehicle.

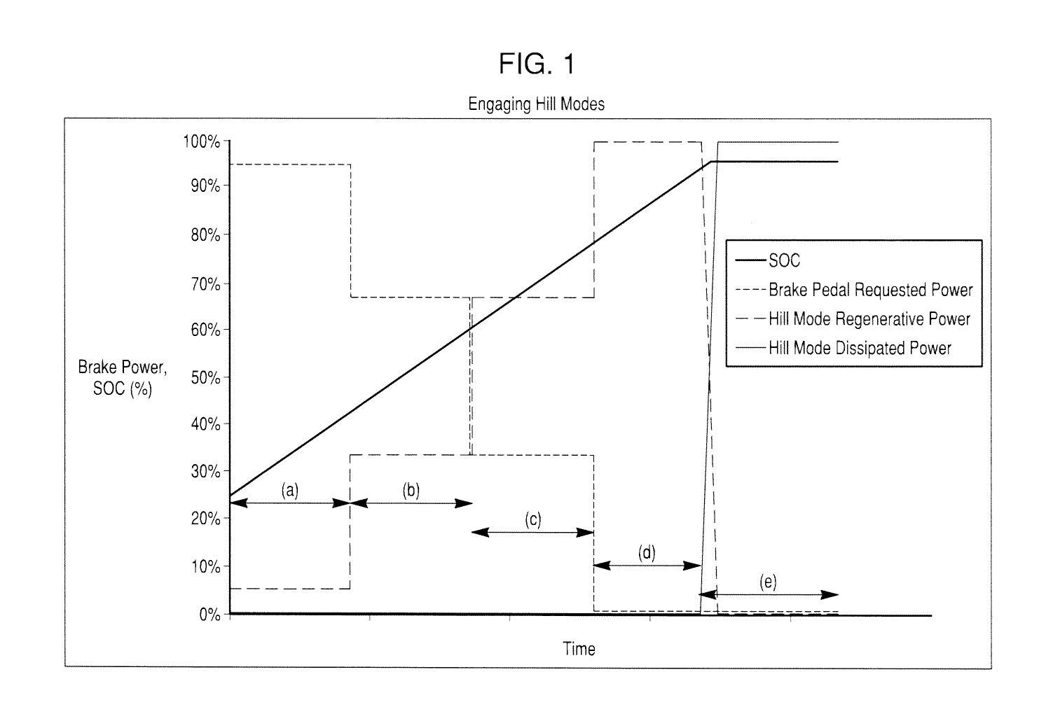

FIG. 1 is a chart representing travel down a steep, constant grade at constant speed. It shows RESS state of charge (SOC), manually requested brake power, and brake power automatically engaged by hill mode (regenerative and dissipated). For the time associated with interval (a), hill mode is off (e.g., the vehicle is operating in either sport or stealth mode). The powertrain provides a minimum resistance by default when the brake pedal is not depressed. In this example, the brake pedal requests the remaining majority of braking power to maintain constant speed. The braking in time intervals (a) through (d) is regenerative, whether automatically requested based on operating mode or manually requested by the brake pedal. The regenerative braking causes the RESS to store energy received from the regenerative braking.

During time interval (b), the vehicle is operating in hill mode 1 (H1). In H1, the powertrain provides more resistance (e.g., than either of stealth or sport mode) when no brake pedals are depressed. The majority of the braking power required to maintain constant speed is still requested by the brake pedal. However, the brake pedal is depressed less than in interval (a). FIG. 1 shows automatic brake power requested by H1 at around 30% and brake pedal requested brake power at about 70%.

During time interval (c), the vehicle is operating in hill mode 2 (H2). In H2, the powertrain provides more resistance (e.g., than in H1) when the brake pedal is not depressed. The minority of the braking power required to maintain constant speed is requested by the brake pedal. In this example, automatic hill mode braking power is about 70% and brake pedal-requested power is about 30%.

During time interval (d), the vehicle is operating in hill mode 3 (H3). In H3, the powertrain provides strong resistance when no brake pedals are depressed so that the vehicle is maintained at a constant speed. Manually requested braking is at about 0% while the automatic braking is at about 100%.

During time interval (e), the vehicle is still operating in H3. As the RESS reaches its maximum SOC, the vehicle transitions from storing energy to dissipating energy, for example, using (but not limited to) the methods provided in the disclosure. This allows the driving experience to remain consistent regardless of the RESS SOC.

In various embodiments, stealth mode provides a look, feel, and/or sound associated with advanced technology. This effect, for example, can provide a sense of stealth jets, military technology, spy James-Bond-style technology, and/or the like. In various embodiments, stealth mode also highlights the acoustic signature of the vehicle in electric operation, particularly because the electric powertrain runs quietly.

The term “sport” is commonly used in the automotive industry to associate with acceleration, speed, and handling performance. According to various embodiments, sport mode may be associated with a hybrid vehicle using more than one power source to achieve performance targets.

In various embodiments, hill mode may be used in various circumstances to reduce the need for traditional braking. For example, when the vehicle is in heavy traffic or other related situations, hill mode may be implemented to take advantage of regenerative braking rather than manual braking.

In various embodiments, hill mode allows the vehicle to vary gearing or downhill resistance continuously with controls or a special transmission, e.g. continuously, infinitely, or electronically variable transmission (CVTs, IVTs, & EVTs). In an example, the vehicle has only one gear ratio between the drive motors and the wheels and fully blended regenerative braking.

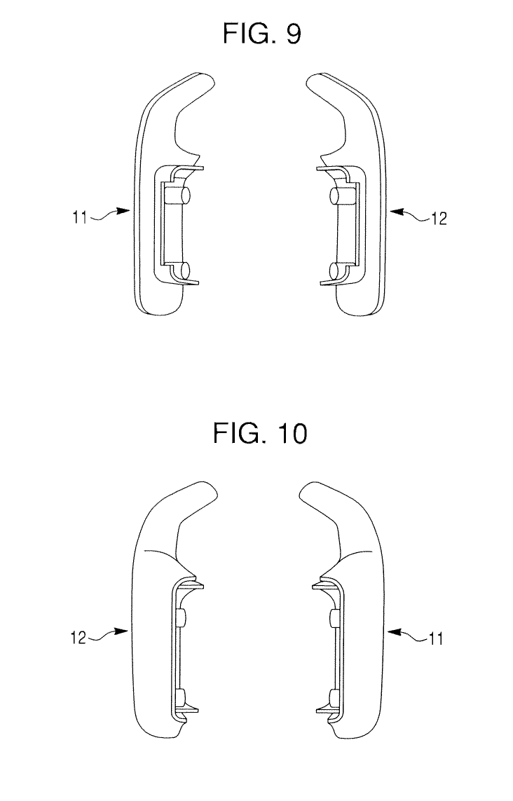

FIGS. 2-10 relate to example steering wheels 10 for an example vehicle associated with the modes described in the disclosure. FIGS. 2-8 show an example steering wheel 10 having a sport hand paddle 11 and a hill hand paddle 12 mounted in opposite positions. A center portion 13 provides an aesthetic cover for various electrical components associated with at least the paddles 11 and 12. The dashboard 14 can include a display for showing various mode operations as well as speed and other associated vehicle conditions. FIGS. 9 and 10 illustrate example hand paddles for sport paddle 11 and hill paddle 12. Each paddle can identify the word “sport” and “hill” respectively for the added convenience of the driver. Although the paddles 11 and 12 are positioned near the circumference of the steering wheel at convenient hand positions for a typical driver, it is understood that the paddles can be disposed at various positions on the wheel or in the vehicle.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A system for controlling a mode of operation of a vehicle having a rechargeable energy storage system (RESS), an engine, and a drive motor coupled to the RESS and the engine, the drive motor selectively powered by at least one of the RESS and the engine, the system comprising:
a controller operable to adjust the vehicle to operate in a plurality of operating modes including a first mode in which the drive motor is powered by the RESS, a second mode in which the drive motor is powered more by the engine than the RESS, and a third mode in which the drive motor is powered by both the RESS and the engine;
wherein the third mode includes a plurality of braking modes adjusting the level of automatic brake power and manually requested brake power for providing resistance to the vehicle as the vehicle travels.

2. The system of claim 1, wherein the plurality of braking modes includes at least a first braking mode in which a greater percentage of resistance is provided by the manually requested brake power than the automatic brake power and a second braking mode in which a greater percentage of resistance is provided by the automatic brake power than the manually requested brake power.

3. The system of claim 1, wherein the automatic brake power provides resistance to the vehicle via engine braking of the engine.

4. The system of claim 1, wherein the automatic brake power provides resistance to the vehicle via regenerative braking.

5. The system of claim 4, wherein the RESS is configured to store at least some energy generated by the regenerative braking.

6. The system of claim 1, wherein the automatic brake power provides resistance to the vehicle via brakes of the vehicle.

7. The system of claim 1, wherein the manually requested brake power provides resistance to the vehicle via brakes of the vehicle.

8. The system of claim 7, wherein the manually requested brake power is provided in response to actuation of a brake pedal of the vehicle.

9. The system of claim 1, further comprising:
a sensor for detecting a grade of the road on which the vehicle is traveling;
wherein the controller changes the operating mode based on the detected grade of the sensor.

10. The system of claim 1, further comprising:
a global positioning circuit for determining a grade of the road on which the vehicle is traveling;
wherein the controller changes the operating mode based on the determined grade of the global positioning circuit.

11. The system of claim 1, wherein the drive motor is power only by the RESS in the first mode.

12. The system of claim 1, wherein the drive motor is power more by the RESS than the engine in the first mode.

13. The system of claim 1, wherein the RESS comprises a high-voltage battery.

14. The system of claim 1, wherein the engine comprises an internal combustion engine.

15. A method of manufacturing a system for controlling a mode of operation of a vehicle having a rechargeable energy storage system (RESS), an engine, and a drive motor coupled to the RESS and the engine, the drive motor selectively powered by at least one of the RESS and the engine, the method comprising:
configuring a controller operable to adjust the vehicle to operate in a plurality of operating modes including a first mode in which the drive motor is powered by the RESS, a second mode in which the drive motor is powered more by the engine than the RESS, and a third mode in which the drive motor is powered by both the RESS and the engine;
wherein the third mode includes a plurality of braking modes adjusting the level of automatic brake power and manually requested brake power for providing resistance to the vehicle as the vehicle travels.
